(19) United States
(12) Patent Application Publication
(10) Pub. No.: US 2008/0270084 A1
(43) Pub. Date: Oct. 30, 2008

(54) Tire Design Method

(75) Inventor: Naoya Ageishi, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/106,384

(22) Filed: Apr. 21, 2008

(30) Foreign Application Priority Data
Apr. 27, 2007 (JP) 2007-118714

(51) Int. Cl. G06F 17/50

(52) U.S. Cl. 703/1

(57) ABSTRACT

An FEM model of an original shape of a block constituting a tread pattern is created, and FEM models of a plurality of base shapes which have the same number of nodes and the same element combination information as those of the original shape and which have different node coordinate values are created based on the original shape. A difference between a vector whose components are the coordinate values of a node of the original shape and a vector whose components are the coordinate values of a node of a base shape is defined as a basis vector. Such basis vectors are linearly combined to define a vector whose components are the coordinate values of each node of the optimization model. A weighting factor for the linear combination is set as a design variable, and a set of values of the design variables for optimizing the objective function are obtained based on an expression representing a relationship between the vector of the model for optimization and the basis vectors.

### CROSS-REFERENCE TO RELATED APPLICATIONS

This application is based upon and claims the benefit of priority from the prior Japanese Patent Applications No. 2007-118714, filed on Apr. 27, 2007; the entire contents of which are incorporated herein by reference.

### BACKGROUND

The present invention relates to a tire design method, a program for the same, and a tire manufacturing method using the design method.

A plurality of blocks are formed on a tread surface of a pneumatic tire to configure a tread pattern. Since a tread pattern has significant influence on water-discharge performance, braking performance, and noises, there are demands for optimal designs of blocks or tread patterns.

For example, the following method is known as a method for designing such an optimal block shape efficiently (see JP-A-2005-008011, U.S. Pat. No. 5,710,718 A, U.S. Pat. No. 6,230,112 B1 and U.S. Pat. No. 6,531,012 B2). The method specifically has the steps of:

(1) modeling an initial tire block using the finite element method;

(2) determining an objective function representing a physical quantity of evaluating tire performance and design variables representing a block shape and the like;

(3) creating a finite element model for optimization to obtain an optimal solution; and

(4) designing an actual block of a tire based on the optimal solution.

In the above-described related method of optimizing a block shape, elements which directly determine a block shape such as the length and shape of each edge of the block are used as design variables. For this reason, according to the method, it is limited to block shapes which can be defined by parameters having a fixed form such as straight lines and sine curves. Therefore, the method limits the range for searching an optimal solution, and it has a problem that a mesh forming finite elements must be re-created each time a design variable is changed.

Methods of optimizing structures using basis vector method are disclosed in JP-A-2002-149717 and JP-A-2005-065996. JP-A-2002-149717 and JP-A-2005-065996 disclose optimization of the shape of a disk arm and optimization of the shape of a golf club head, respectively. Both of the publications address methods for optimizing relatively simple shapes and does not propose optimization of complicated shapes such as tire tread patterns.

### SUMMARY

The invention was made taking the above-described point into consideration, and it is an object of the invention to provide a tire design method which allows an optimal solution to be searched in a wider range and which therefore makes it possible to find a shape of a tread pattern that is optimal for required tire performance.

A tire design method according to an embodiment of the invention includes the steps of:

(a) deciding an objective function associated with tire performance;

(b) creating a model of an original shape of at least a part of a tire tread pattern by dividing elements of the original shape into the form of a mesh;

(c) creating models of a plurality of base shapes which have the same number of nodes and the same element combination information as those of the model of the original shape and which have different node coordinate values, based on the model of the original shape;

(d) defining a basis vector from a vector whose components are the coordinate values of a node of the original shape and a vector whose components are the coordinate values of a node of the base shape, defining a vector whose components are the coordinate values of each node of a model for optimization by linearly combining basis vectors, and setting a weighting factor for the linear combination as a design variable;

(e) obtaining a set of values of the design variables for optimizing the objective function based on an expression representing a relationship between the vector of the model for optimization and the basis vectors; and

(f) deciding the shape of at least a part of the tire tread pattern based on the values of the design variables obtained.

Referring to the definition of a basis vector at the step (d), for example, a difference between a vector whose components are the coordinate values of a node of the original shape and a vector whose components are the coordinate values of a node of a base shape may be defined as a basis vector. Alternatively, each of the vector whose components are the coordinate values of a node of the original shape and the vector whose components are the coordinate values of a node of a base shape may be defined as a basis vector.

In an embodiment of the invention, a program for designing a tire using a computer is provided, and the program causes the computer to execute the above-described steps. In another embodiment of the invention, there is further provided a tire manufacturing method characterized in that a tire is designed and manufactured using the above-described design method.

### BRIEF DESCRIPTION OF THE DRAWINGS

FIG. 1 is a flow chart showing a flow of processes of a tire design method according to an embodiment of the invention;

FIG. 2 is a flow chart showing a flow of optimization calculations according to the embodiment;

FIG. 3is a perspective view of an FEM model of an original shape of a block according to Example 1;

FIG. 4A is a plan view of the original shape in Example 1, and FIGS. 4B, 4C, and 4D are plan views of base shapes 1 to 3 in Example 1;

FIGS. 5A and 5B are plan views showing examples of FEM models for optimizing in the embodiment of the invention;

FIG. 6A is a perspective view of a block for explaining FEM analysis conditions in Example 1, and FIG. 6B is a side view of the block;

FIG. 7A is a plan view of an original shape in Example 1, and FIG. 7B is a plan view of an optimized shape in Example 1.

FIG. 8A is a plan view of an original shape in Example 2, and FIGS. 8B, 8C, 8D, and 8E are plan views showing base shapes 1 to 4 in Example 2;

FIG. 9A is a perspective view of a block for explaining FEM analysis conditions in Example 2, and FIG. 9B is a side view of the block; and

FIG. 10A is a plan view of an original shape in Example 2, and FIG. 10B is a plan view of an optimized shape in Example 2.

### DETAILED DESCRIPTION

In an embodiment of the invention, to optimize the shape of a tire tread pattern, an optimization model on which optimization calculations are performed is created using the basis vector method. Specifically, coordinate values of nodes of a model of a tread pattern original shape are moved with the number of nodes and element combination information kept unchanged to create models of a plurality of base shapes having different node coordinate values. Then, based on the base shapes and the original shapes, an optimization model is generated in the form of linear combinations of the basis vector. Thus, the shape of the tire tread pattern is defined using a weighting factor for each basis vector as a design variable. It is therefore possible to easily create a tread pattern shape which is difficult to define using parameters having fixed forms. As a result, an optimal solution can be searched in a wider range, and tire performance can be further improved. Since each change in a design variable rarely necessitates redefining of the mesh of a model, man-hour for designing can be reduced.

In an embodiment of the invention, the step (e) described above may include the step of calculating the objective function of the optimization model. In this case, when the objective function cannot be calculated because some of elements of the optimization model have a distorted shape, the objective function may be calculated after re-configuring at least the problematic elements of the optimization model by dividing the elements into the form of a mesh.

An embodiment of the invention will now be described in detail with reference to the drawings.

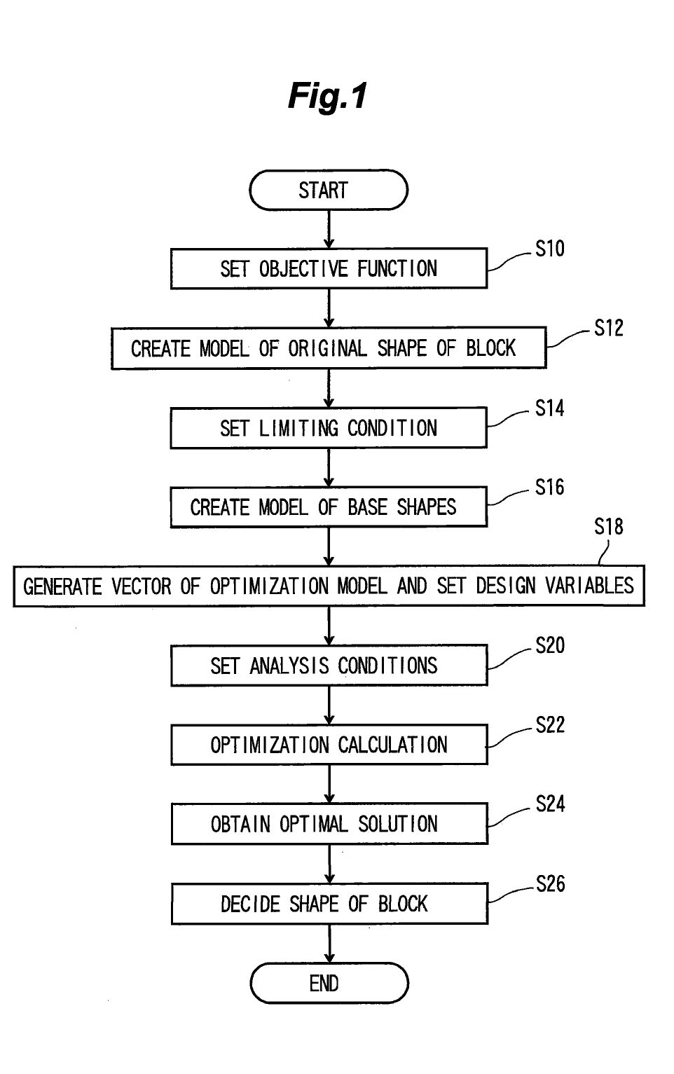

FIG. 1 is a flow chart showing a flow of processes of a tire design method according to an embodiment. The present embodiment relates to a method of optimizing the shape of one block constituting a tread pattern of a pneumatic tire, and the embodiment may be implemented using a computer.

More specifically, the design method of the present embodiment can be carried out by creating a program for causing a computer to execute steps as described below and by using a computer such as a personal computer having such a program stored (installed) in a hard disk thereof. That is, the program stored in the hard disk is read into a RAM as occasion demands to execute the same. Calculations are carried out by a CPU using various data input from an input unit such as a keyboard, and calculation results are displayed by a display unit such as a monitor. Such a program may be stored in various types of computer-readable recording media such as CD-ROMs, DVDs, MDs, and MO disks. Therefore, a drive for such a recording medium may be provided in a computer, and the program may be executed using the drive.

According to the design method of the present embodiment, an objective function associated with tire performance is decided first at step S10. The objective function may be a physical quantity whose value changes depending on the shape of a block. For example, the function may be distribution of a ground contact pressure at the time of braking which is an index of improvement of braking performance or distribution of frictional energy which is an index of improvement of anti biased abrasion performance.

At the next step S12, a finite element model (hereinafter referred to as “FEM” model) of an original shape of a block of interest is created. An original shape is a shape of a block to serve as a reference for coordinate values of each node of an FEM model for optimization which will be described later, and it may be also referred to as “initial shape”. For example, when the shape of a block of an existing tire is to be optimized to improve the characteristics of the tire, the shape of the block of the existing tire may be used as an original shape. Although a model of only a block is created in this example, a model of the tire as a whole including the block may alternatively be created.

The FEM model of the original shape is obtained by dividing the block of the original shape including internal structures thereof into elements into the form of a mesh, and the original shape is modeled such that a physical quantity as described above for evaluating tire performance can be numerically and analytically obtained through an FEM analysis.

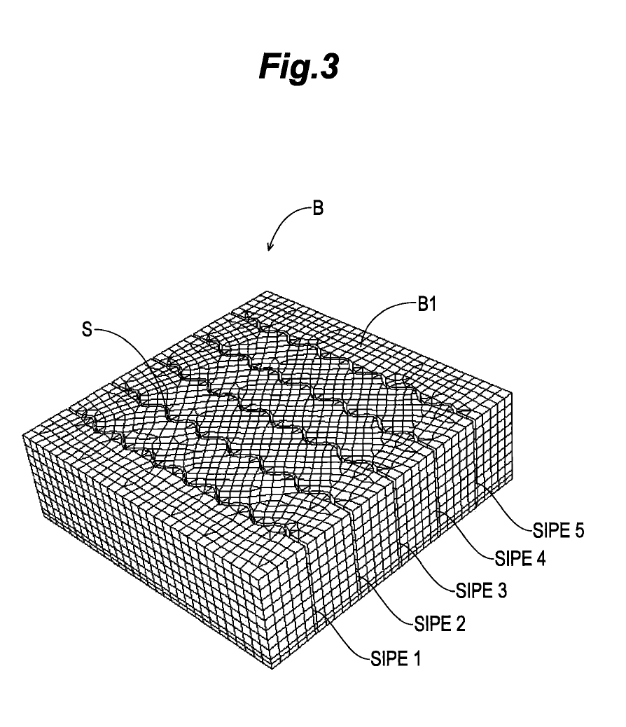

FIG. 3 shows an example of an FEM model of an original shape. A block B is a land portion defined by circumferential grooves and lateral grooves of a tire tread which is not shown. The example shown in FIG. 3 is a land portion which has a rectangular shape in a plan view thereof. Sipes S, which are constituted by a plurality of cuts extending in the width direction of the tire, are spaced in the circumferential direction of the tire in parallel with each other on a top surface B1 (or grounding surface side) of the block. The sipes S are formed to have a wavy shape in a plan view thereof. In this example, five sipes, i.e., sipes 1 to 5 are provided. The depth of the sipes S is set smaller than the thickness of the block B.

At the next step S14, limiting conditions are set. For example, the limiting conditions include requirements that the block should have a constant grounding area and that the sum of the depths of the five sipes S in the block shape shown in FIG. 3 should be constant.

At the next step S16, FEM models of a plurality of base shapes are created based on the FEM model of the original shape. A base shape is a block shape which has the same number of nodes and element combination information as those of the original shape and which has node coordinate values different from those of the original shape. The number of nodes is the total number of mesh intersections forming the FEM model. Element combination information is information indentifying nodes included in each element constituting the FEM model and indicating the order in which the nodes are included. Node coordinate values are coordinate values indicating the position of each node relative to an origin serving as a reference.

The FEM models of the base shapes are created such that they have shapes different from the original shape by varying the node coordinate values of the FEM model of the original shape with the number of nodes and element combination information kept unchanged. Referring to the method of varying the node coordinate values, an operator may vary the node coordinate values of the FEM model of the original shape using an input unit such as a mouse while monitoring an image of the model. Alternatively, the node coordinate values may be automatically varied by a computer according to predetermined rules. Although there is no particular limitation on the number of base shapes created, it is normally preferable to create 10 or less such shapes when computational costs are considered. The number may be input by an operator based on a request signal from a computer.

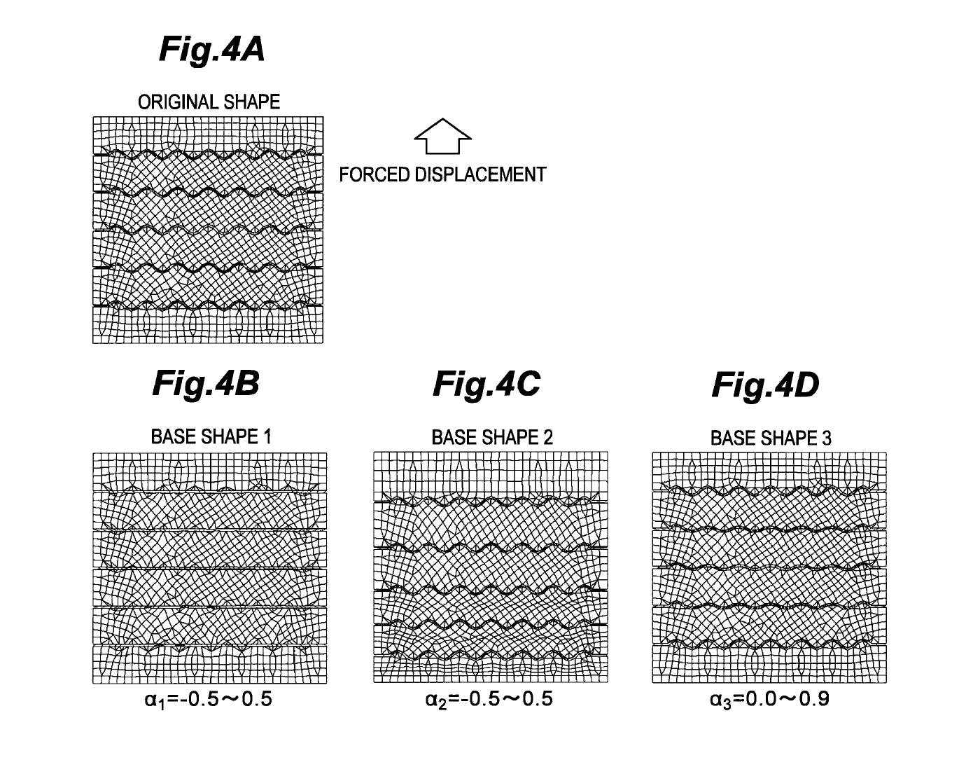

For example, FEM models of a plurality of base shapes can be created from the block shape shown in FIG. 3 by varying the amplitude of the waves throughout the sipes S, the amplitude of waves in the middle of the sipes S, the intervals between the sipes S or the depths of each sipe S. FIG. 4A shows the FEM model of the original shape of the block shape shown in FIG. 3, and FIGS. 4B, 4C, and 4D show FEM models of three base shapes, i.e., FEM models of a base shape 1 (FIG. 4B), a base shape 2 (FIG. 4C), and a base shape 3 (FIG. 4D), respectively.

At the next step S18, an FEM model for optimization is created, and design variables are set. Specifically, node coordinate values of the FEM models created at steps S12 and S16 are regarded as components of vectors, and new vectors are created by linearly combining those vectors. An FEM model for optimization is configured using coordinate values of each node which are components of the new vectors.

That is, in this example, a difference between a vector whose components are the coordinate values of a node of the original shape and a vector whose components are the coordinate values of a node of a base shape is defined as a basis vector. Such basis vectors are linearly combined to define a vector whose components are the coordinate values of each node of the optimization model. Such a vector of the optimization model is expressed by Equation (1) shown below.

$${\vec{X}}_{VAR} = {\vec{X}}_{ORG} + {\sum }_{i} {α}_{i} ( {\vec{X}}_{ORG} - {\vec{X}}_{BASE , i} ) \qquad ( 1 )$$

where \vec{X}_{ORG} represents a vector whose components are the coordinate values of a node of the original shape; \vec{X}_{BASE,i} represents a vector whose components are the coordinate values a node of a base shape; \vec{X}_{VAR} represents a vector whose components are the coordinate values each node of the optimization model; αᵢ represents a factor for linear combination; and i represents a number assigned to the base shape.

Weighting factors for linear combination represented by αᵢ are defined as design variables in optimization calculations which will be described later. A range of limitation is set for each of the weighting factors. For example, in the examples shown in FIGS. 4B to 4D, a weighting factor α₁ for the base shape 1, a weighting factor α₂ for the base shape 2, and a weighting factor α₃ for the base shape 3 are set in a range from −0.5 to 0.5, a range from −0.5 to 0.5, and a range from 0.0 to 0.9, respectively.

Next, conditions for an analysis involved in optimization calculations are decided at step S20. The analysis conditions are conditions applied to an FEM model when an FEM analysis is carried out, and the conditions include a tire internal pressure, a shear forced displacement, a coefficient of friction with road surface, and physical properties of the rubber material from which the block is made.

At the next step S22, optimization calculations are performed. The optimization calculations are performed based on a relational expression between a vector of the optimization model and basis vectors which is shown above as Equation (1) to obtain values of design variables at which an objective function as described above is optimized. Various known methods of optimization may be used for such optimization calculations. For example, methods involving no sensitivity calculation include design of experiments (DOE) methods and methods utilizing genetic algorithms. Methods involving sensitivity calculations include mathematical programming. Any of those methods may be used. In the present embodiment, an example of optimization calculations according to a DOE method will be described.

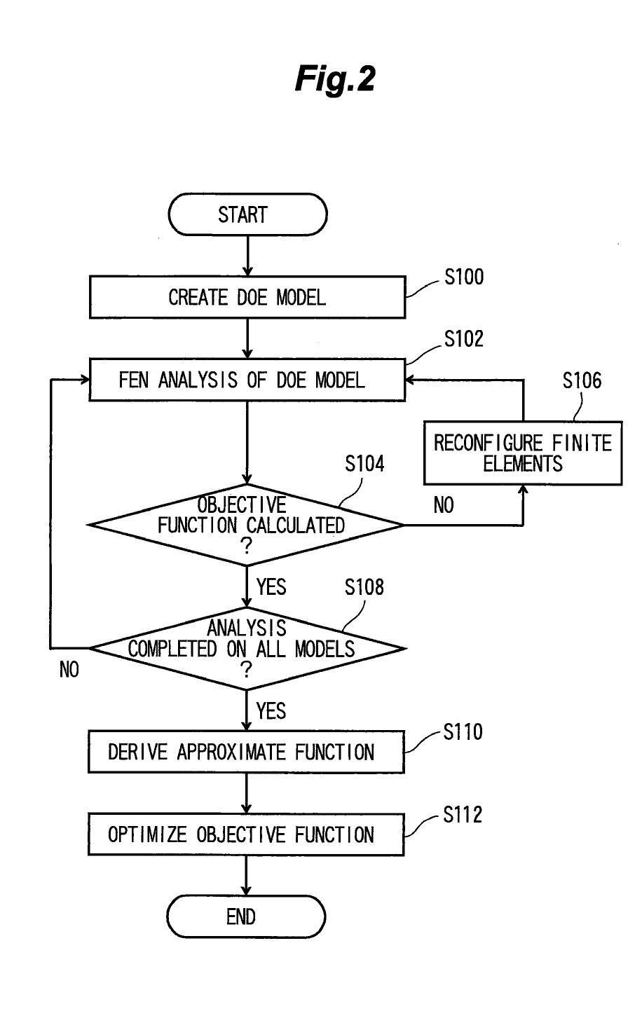

When optimization calculations are performed using a DOE method, as shown in FIG. 2, a plurality of DOE models are created according to conditions for allocation of a design of experiments based on the DOE method at step S100. Specifically, design variables are allocated to columns of an orthogonal table based on the DOE method. Referring to the orthogonal table, since there are three design variables in the present embodiment, an L27 three-level orthogonal table is used. The design variables α₁, α₂, and α₃ are changed to three levels corresponding to a lower limit value, an intermediate value and an upper limit value of the above-mentioned range of limitation and are allocated to the orthogonal table. Then, the values of the design variables are varied according to respective conditions for allocation to create FEM models for optimization in the number of rows of the orthogonal table or 27 FEM optimization models as DOE models according to Equation (1).

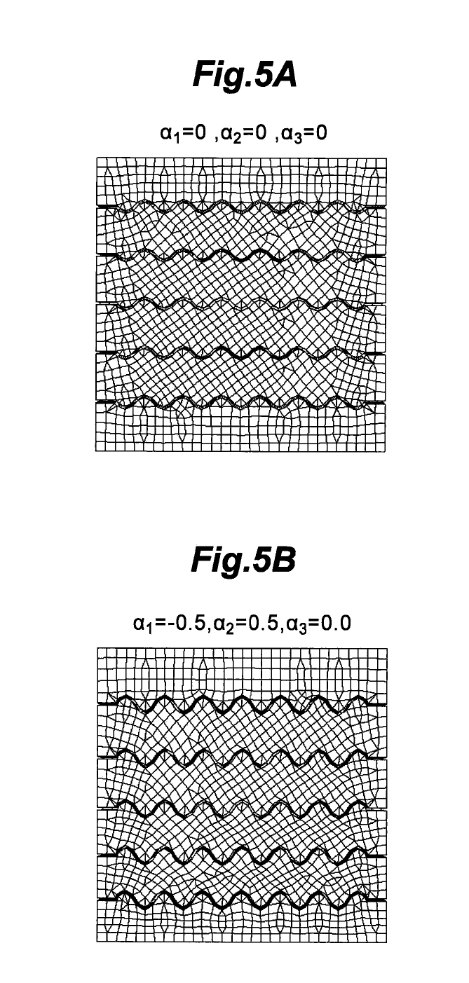

For example, when α₁=0, α₂=0; and α₃=0, the resultant optimization FEM model coincides with the FEM model of the original shape, as shown in FIG. 5A. When α₁=−0.5, α₂=0.5; and α₃=0.0, an optimization FEM model different from any of the original shape and the base shapes is obtained as shown in FIG. 5B.

Next, at step S102, an FEM analysis is carried out to obtain an objective functions for each of the DOE models obtained as described above. Specifically, calculations are performed with the analysis conditions set at step S20 applied to the optimization FEM models to obtain respective objective functions.

Such an FEM analysis may fail to converge, and some objective functions may not be calculated. Such a failure frequently occurs when some of elements of an optimization FEM model created based on the DOE method as described above are a significantly distorted in shape. When no objective function is calculated for a certain optimization FEM model (step S104: No), the mesh is redefined for the distorted elements to reconfigure the elements by dividing the elements into the form of a mesh (step S106). Thereafter, an FEM analysis is carried out using the re-configured optimization FEM model to calculate an objective function (step S102). Thus, the problem of a failure in calculating an objective function can be solved. Since such redefinition is required only for particular regions having distorted elements of a particular FEM model as described above, any increase in computational cost can be avoided.

Such an FEM analysis is repeated until an objective function is calculate for all of the 27 optimization FEM models (step S104: Yes and step S108: No), and the process proceeds to the next step when an objective function is obtained for all of the FEM models (step S108: Yes).

At the next step S110, the objective functions are represented as a function of the design variables from the relationship between the objective functions and the design variables identified as described above. Specifically, the objective functions are converted into an approximate function (response curve) of the design variables by performing polynomial approximation using a method such as regression analysis.

Thereafter, at step S112, design variables at which the objective functions are optimized are obtained from the approximate function. For example, let us assume that the objective function is distribution of the ground contact pressure of the block and it is desired to minimize the ground contact pressure distribution. Then, the design variables included in the approximate function are varied to minimize the ground contact pressure distribution, whereby an optimal solution is obtained.

After an optimal solution is obtained as thus described (step S24), the shape of the block is decided based on the optimal solution of the design variables as thus obtained (step S26). Vulcanization molding can be carried out according to a normal method to manufacture a pneumatic tire having a block shape designed as thus described in practice. It is therefore possible to provide a pneumatic tire which is improved in tire performance associated with an objective function as described above.

The above-described embodiment is obviously different from optimization methods according to the related art in the way of providing design variables determining the shape of a block. Specifically, a model for optimization to be subjected to calculations for optimizing the shape of a block is generated using a weighting factor for each basis vector as a design variable according to the basis vector method as described above. It is therefore possible to easily create a block having a complicated shape which is difficult to define using a parameter having a fixed form. Thus, an optimal solution can be searched in a wider range, and tire performance can be improved. Since each change in a design variable rarely necessitates redefining of the mesh of a model, man-hour for designing can be reduced.

Although a block shape to be optimized is represented on a three-dimensional basis in the above-described embodiment, the invention may be applied to two-dimensional shapes. While the above-described embodiment employs an FEM-based analyzing technique, an analyzing technique according to BEM (boundary element method) or FVM (finite volume method) may alternatively be used.

While the above embodiment has addressed a case in which the shape of one block of a tire tread pattern is optimized, the invention is not limited to optimization of a single block as thus described. What is required for optimizing a shape is that it is at least a part of a tread pattern. Therefore, the optimization may be carried out on a tread pattern as a whole, a part of a tread pattern extending in the circumferential direction thereof, e.g., merely a part which comes into contact with ground, or only one pitch of a tread pattern. When a tread pattern is to be optimized as thus described, it is preferable to create a model of the tire as a whole rather than creating a model of only blocks. That is, a model of a patterned tire may be used as a model for optimization.

### EXAMPLES

A description will now be made on examples of optimization of the shape of a block using the optimization method according the above-described embodiment.

### Example 1

### Optimization of Sipe Shape

An object of this example was to optimize the shape of the sipes of the block B having the original shape shown in FIG. 3 in order to achieve high braking performance on an icy road surface. The objective function was distribution of the ground contact pressure of the block at the time of braking, and the problem was to minimize the distribution.

At step S16 as described above, models of base shapes were created by varying the amplitude of waves throughout the sipes S, the amplitude of waves in the middle of the sipes S, and the intervals between the sipes S. Thus, three base shapes 1 to 3 as shown in FIGS. 4B, 4C, and 4D were created.

In this example, the base shapes were created by changing only the shape (two-dimensional shape) of a ground contact surface of the block. The depth of each of the sipes S was used as an independent design variable (the sipes had depths in the range from 2.0 to 8.0 mm, and the block had a thickness of 8.5 mm), and the independent design variables were allocated to an L27 three-level orthogonal table based on the DOE method along with design variables α₁, α₂, and α₃ as described above serving as weighting factors to perform optimization calculations.

Limiting conditions were that the grounding area of the block should be constant and that the sum of the depths of the five sipes S should be constant at 20 mm.

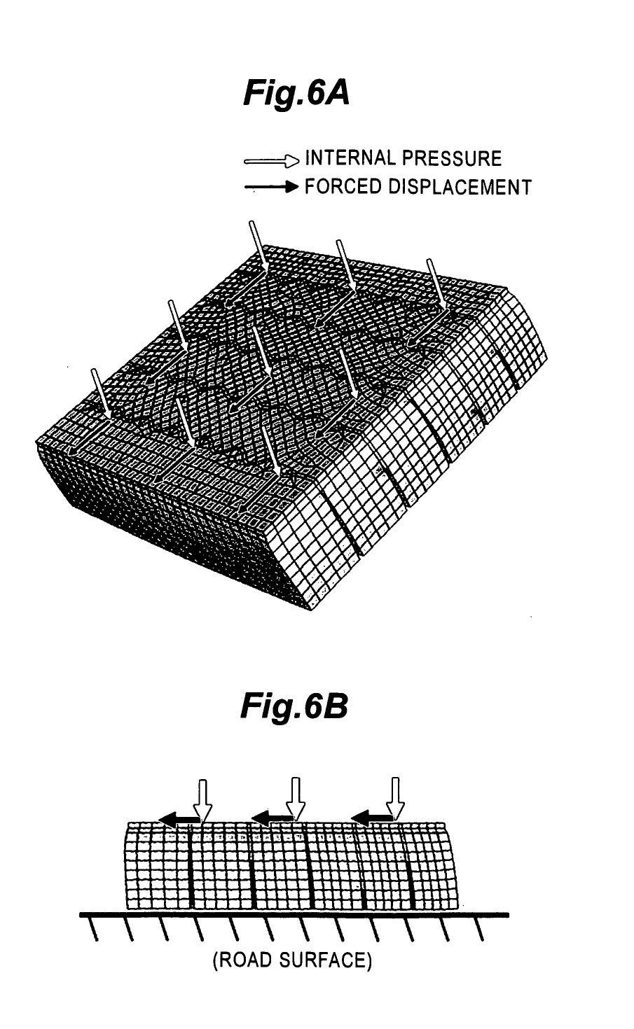

Referring to analysis conditions, it was assumed that a vertical load (an interval pressure shown in FIGS. 6A and 6B) of 200 kPa was applied to the block; there was a shear forced displacement (a forced displacement shown in FIGS. 6A and 6B) of 1.0 mm as a forced displacement; and the coefficient of friction with road surface was 0.15.

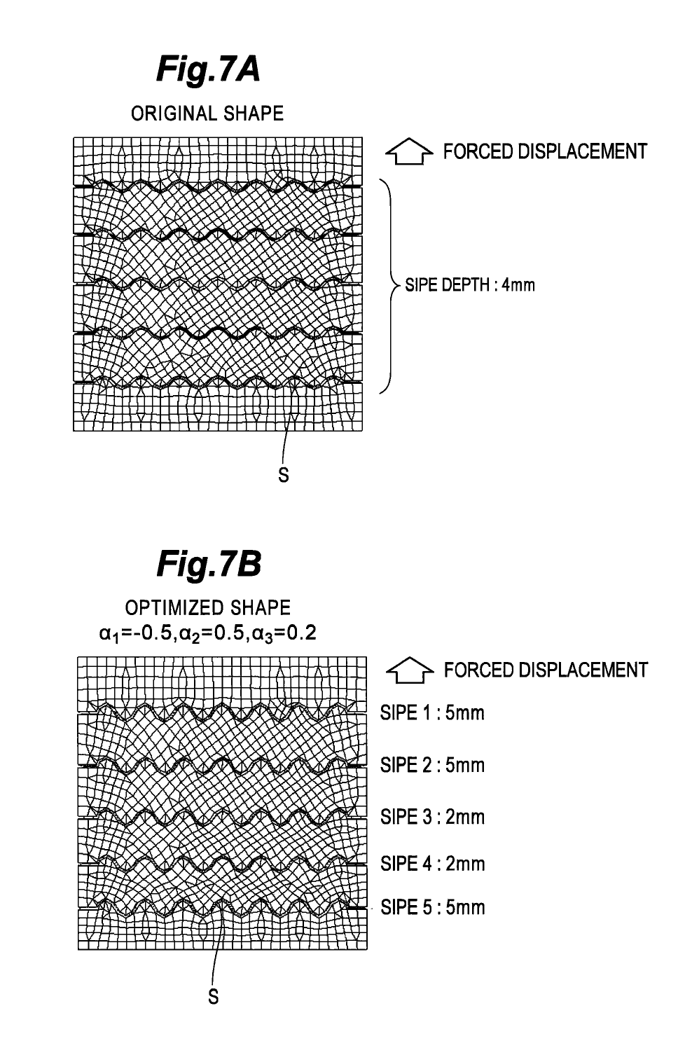

As a result, optimal solutions for the design variables α₁, α₂, and α₃ were −0.5, 0.5, and 0.2, respectively, and an optimized shape as shown in FIG. 7B was obtained. In this optimized shape, the sipes S had amplitudes greater than those of the original shape shown in FIG. 7A, and the intervals between the sipes S were greater in a forward side (top side of FIG. 7B) and smaller in a backward side (bottom side of FIG. 7B) in the direction of the forced displacement. Referring to the depths of the sipes S, the sipes in the middle of the block were shallower than the sipes on both sides of the block.

The block in the optimized shape had a ground contact pressure distribution of 86.4 on an assumption that the block having the original shape (conventional product) had a ground contact pressure distribution of 100. Thus, there was a significant improvement in ground contact pressure distribution.

### Example 2 Optimization of Block Shape

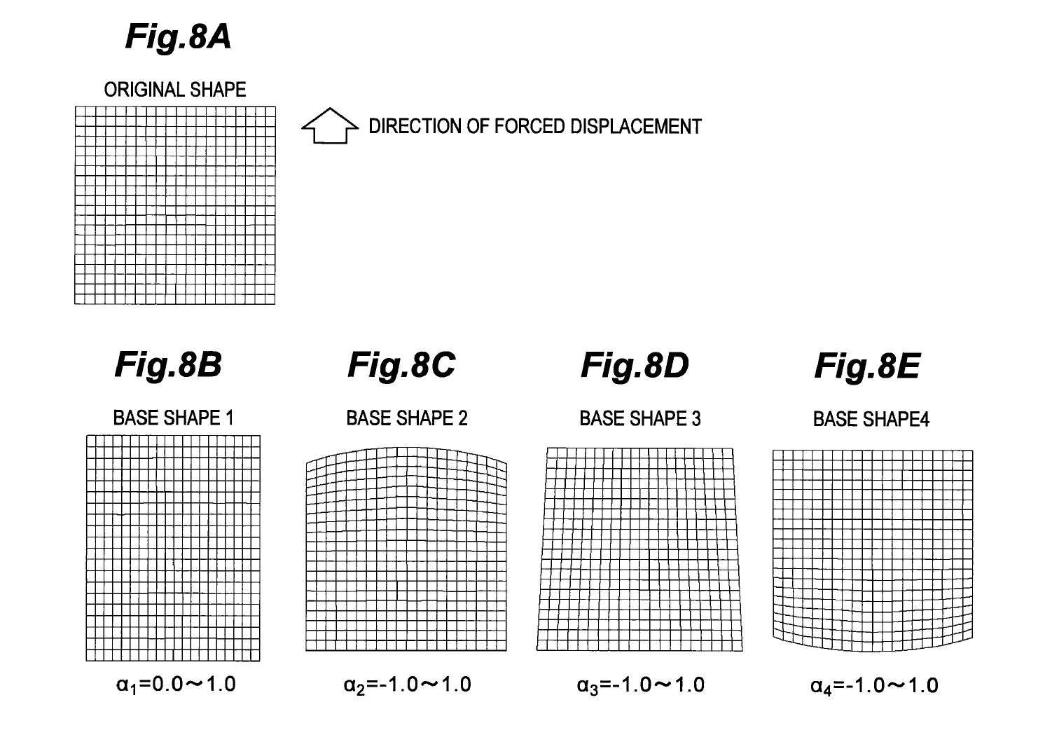

An object of this example was to obtain a block shape providing high braking performance on an icy road surface through optimization for a block having an original shape as shown in FIG. 8A. The objective function was distribution of the ground contact pressure of the block at the time of braking, and the problem was to minimize the distribution.

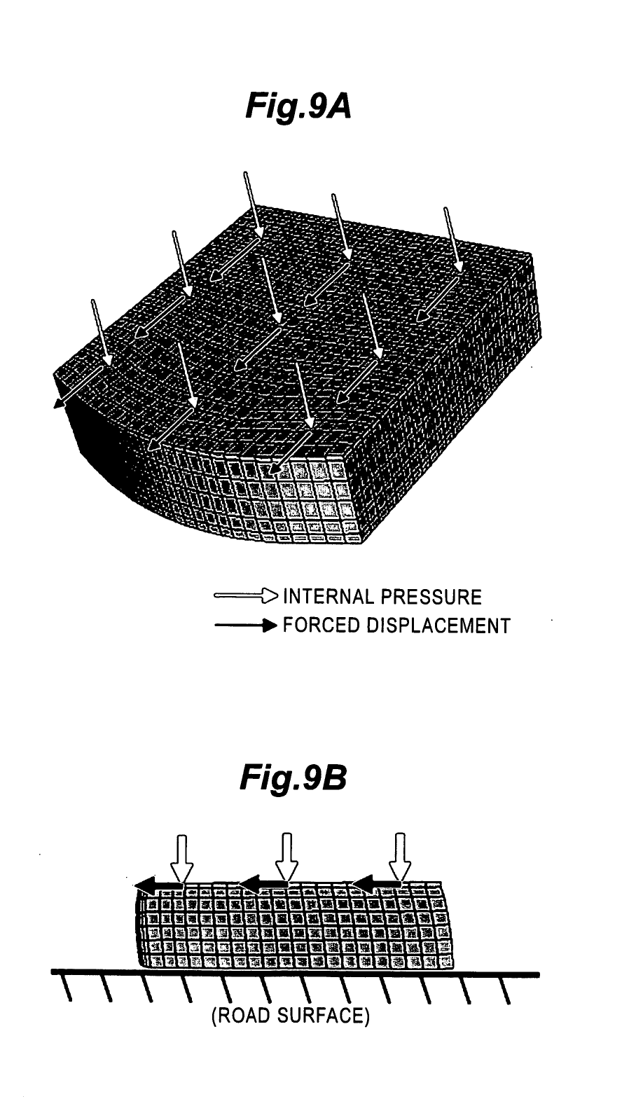

Four base shapes 1 to 4 as shown in FIGS. 8B, 8C, 8D and 8E were created. Limiting conditions were that the grounding area of the block should be constant. Referring to analysis conditions, it was assumed that a vertical load (an interval pressure shown in FIGS. 9A and 9B) of 200 kPa was applied to the block and that there was a shear forced displacement (a forced displacement shown in FIGS. 9A and 9B) of 1.0 mm as a forced displacement. The coefficient of friction with road surface was 0.3. The block had a thickness of 8.5 mm.

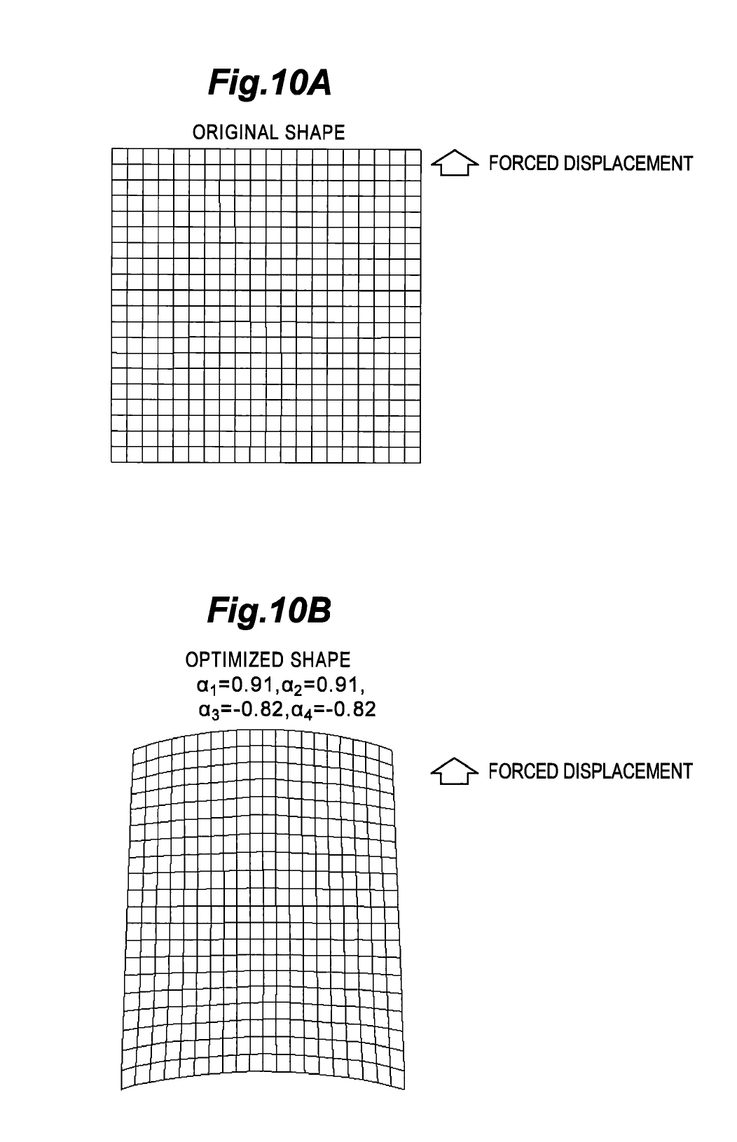

As a result, optimal solutions for design variables α₁, α₂, α₃, and α₄ were 0.91, 0.91, −0.82, and −0.82, respectively, and an optimized shape as shown in FIG. 10B was obtained. This optimized shape was elongated in the direction of the forced displacement when compared to an original shape shown in FIG. 10A. The edge of the optimized shape on a forward side (top side of FIG. 10B) was in the form of a curve projecting forward, and the edge of the same on a backward side (bottom side of FIG. 10B) was in the form of a concave curve.

The block in the optimized shape had a ground contact pressure distribution of 73.8 on an assumption that the block having the original shape (conventional product) had a ground contact pressure distribution of 100. Thus, there was a significant improvement in ground contact pressure distribution.

The invention can be advantageously used for designing tread patterns of various tires such as pneumatic radial tires.

What is claimed is:

1. A tire design method comprising:
(a) deciding an objective function associated with tire performance;
(b) creating a model of an original shape of at least a part of a tire tread pattern by dividing the original shape into elements in the form of a mesh;
(c) creating models of a plurality of base shapes which have the same number of nodes and the same element combination information as those of the model of the original shape and which have different node coordinate values, based on the model of the original shape;
(d) defining a basis vector from a vector whose components are the coordinate values of a node of the original shape and a vector whose components are the coordinate values of a node of the base shape, defining a vector whose components are the coordinate values of each node of a model for optimization by linearly combining basis vectors, and setting a weighting factor for the linear combination as a design variable;
(e) obtaining a set of values of the design variables for optimizing the objective function based on an expression representing a relationship between the vector of the model for optimization and the basis vectors; and
(f) deciding the shape of at least a part of the tire tread pattern based on the values of the design variables obtained.

2. A tire design method according to claim 1, wherein:
the step (e) includes the step of calculating an objective function of the model for optimization; and
when the objective function cannot be calculated because some of elements of the model for optimization have a distorted shape, the objective function is calculated after re-configuring at least the problematic elements of the model for optimization by dividing the elements into the form of a mesh.

3. A tire design method according to claim 1, wherein the shape of at least a part of the tire tread pattern is the shape of a block constituting the tire pattern.

4. A tire design method according to claim 3, wherein sipes constituted by a plurality of cuts are provided on a surface of the block.

5. A tire manufacturing method comprising designing and manufacturing a tire using the method according to claim 1.

6. A program for designing a tire using a computer, stored in a computer-readable medium for causing the computer to execute the steps of:
(a) deciding an objective function associated with tire performance;
(b) creating a model of an original shape of at least a part of a tire tread pattern by dividing the original shape into elements in the form of a mesh;
(c) creating models of a plurality of base shapes which have the same number of nodes and the same element combination information as those of the model of the original shape and which have different node coordinate values, based on the model of the original shape;
(d) defining a basis vector from a vector whose components are the coordinate values of a node of the original shape and a vector whose components are the coordinate values of a node of the base shape, defining a vector whose components are the coordinate values of each node of a model for optimization by linearly combining basis vectors, and setting a weighting factor for the linear combination as a design variable;
(e) obtaining a set of values of the design variables for optimizing the objective function based on an expression representing a relationship between the vector of the model for optimization and the basis vectors; and
(f) deciding the shape of at least a part of the tire tread pattern based on the values of the design variables obtained.
